(19) United States
(12) Patent Application Publication
(10) Pub. No.: US 2008/0285613 A1
(43) Pub. Date: Nov. 20, 2008

(54) COLPITTS RF POWER OSCILLATOR FOR A GAS DISCHARGE LASER

(75) Inventor: Michael W. Murray, Mukilteo, WA (US)

Correspondence Address: EDWARDS ANGELL PALMER & DODGE LLP, P.O. BOX 55874, BOSTON, MA, 02205, US

(73) Assignee: Synrad, Inc., Mukilteo, WA (US)

(21) Appl. No.: 11/750,273

(22) Filed: May 17, 2007

(51) Int. Cl. H01S 3/097

(52) U.S. Cl. 372/55; 372/82

(57) ABSTRACT

A Colpitts oscillator that includes an RF-excited gas discharge laser tube as the feedback pi-network of the Colpitts oscillator.

### FIELD OF THE INVENTION

The invention is related to a radio-frequency (RF)-excited gas discharge lasers, and in particular but not exclusively, to a self-oscillating dual tap RF-excited gas discharge laser.

### BACKGROUND OF THE INVENTION

A radio frequency (RF)-excited gas laser produces laser energy when a gas medium within the laser is excited by the application of RF energy between a pair of electrodes. One example of a gas laser is a carbon dioxide laser. RF-excited gas lasers have found many applications because of their compact size, reliability, and relative ease of manufacture.

### BRIEF DESCRIPTION OF THE DRAWINGS

Non-limiting and non-exhaustive embodiments of the present invention are described with reference to the following drawings, in which:

FIG. 1A shows a block diagram of an embodiment of an oscillator including a laser tube;

FIG. 1B shows a block diagram of an embodiment of the oscillator of FIG. 1A;

FIG. 2 illustrates a block diagram of another embodiment of the oscillator of FIG. 1A;

FIG. 3 illustrates a block diagram of yet another embodiment of the oscillator of FIG. 1A;

FIG. 4 shows a schematic diagram of an embodiment of the oscillator of FIG. 3;

FIG. 5 schematically illustrates of an embodiment of the oscillator of FIG. 4;

FIG. 6A shows a block diagram of an embodiment of the laser device of FIG. 1A;

FIG. 6B shows a three-dimensional perspective of an embodiment of the laser device of FIG. 6A; and

FIG. 7 illustrates a block diagram of an embodiment of the laser device of FIG. 6A, arranged in accordance with aspects of the present invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “coupled” means at least either a direct electrical connection between the items connected, or an indirect connection through one or more passive or active intermediary devices. The term “circuit” means at least either a single component or a multiplicity of components, either active and/or passive, that are coupled together to provide a desired function. The term “signal” means at least one current, voltage, charge, temperature, data, or other signal. Where either a field effect transistor (FET) or a bipolar junction transistor (BJT) may be employed as an embodiment of a transistor, the scope of the words “gate”, “drain”, and “source” includes “base”, “collector”, and “emitter”, respectively, and vice versa. Further, where an RF power grid tube may be used in place of a transistor, the scope of the words “grid”, “plate”, and “cathode” includes “gate”, “drain”, and “source” respectively, and vice versa.

Briefly stated, the invention is related to a Colpitts oscillator that includes an RF-excited gas discharge laser tube as the feedback pi-network of the Colpitts oscillator.

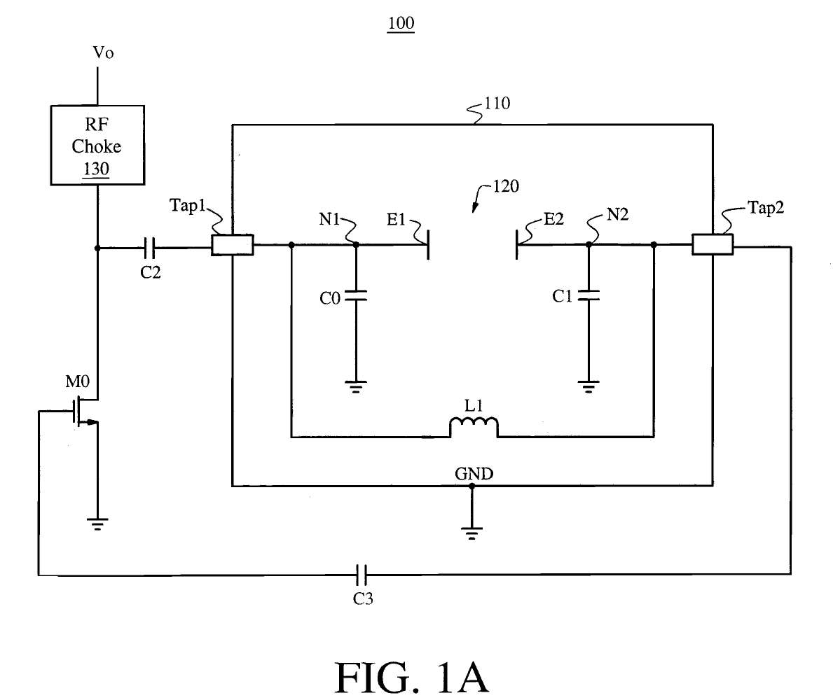

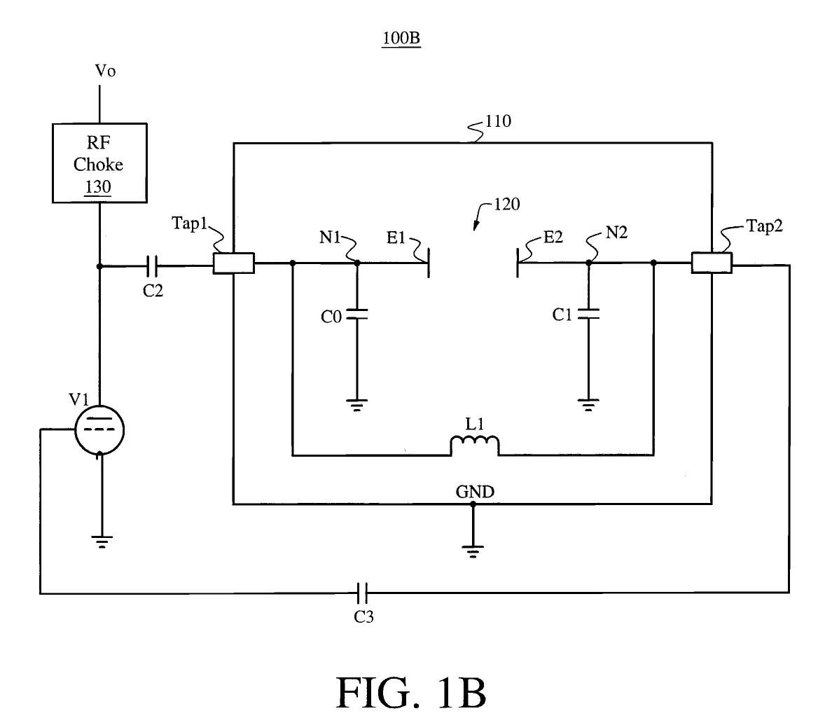

FIG. 1A shows a block diagram of an embodiment of oscillator 100. Oscillator 100 includes laser tube 110, additional oscillator circuitry, and RF choke 130. In one embodiment, the oscillator circuitry includes capacitor C2, capacitor C3, and transistor M0. In other embodiments, the oscillator circuitry may include more or less components. For example, in some embodiments, additional passive components (not shown in FIG. 1A) may be included in series with capacitor C3. Similarly, in some embodiments, additional components, such as an inductor (not shown in FIG. 1A), may be included in series with capacitor C2. In another embodiment, capacitor C2 is replaced with an inductor. These variations and others are within the scope and spirit of the invention.

Laser tube 110 is a radio frequency (RF)-excited gas discharge laser tube. Virtually any RF-excitable gas discharge laser tube may be used for laser tube 110, although some laser tubes may need to be modified to ensure that that is a first tap connected to a first electrode and a second tap connected to the second electrode. Laser tube 110 has a ground input GND, a first tap Tap1 connected to node N1, and a second tap Tap2 connected to node N2. Electrode E1 is connected to node N1, and electrode E2 is connected to node N2. Also, there is a discharge region 120 between electrode E1 and electrode E2. A gas load, such as carbon dioxide or other type of lasing gas, fills discharge region 120 during operation of the laser. When excited by an RF signal provided by oscillator 100, an electric field develops between electrode E1 and electrode E2, causing plasma breakdown and therefore a discharge in the gas load in discharge region 120.

Capacitance C0 represents the lumped equivalent capacitance at node N1, and capacitance C1 represents the lumped equivalent capacitance at node N2. Inductor circuit L1 may include one coil, or by two or more coils arranged in series and/or in parallel to provide an equivalent inductance L1. Capacitances may also be includes among the coils. In one embodiment, inductor circuit L1 includes two or more inductive coils that are each in parallel with discharge region 120.

Oscillator 100 is arranged as a classic Colpitts oscillator, except that laser tube 110 is the feedback pi-network of the Colpitts oscillator. Laser tube 110 is accordingly arranged for self-oscillation for RF excitation where laser tube 110 is part of the oscillator.

RF choke 130 is provides DC voltage at its output at the operating frequency. RF choke 130 is arranged to allow DC current to flow to the drain of transistor M0 without letting any of the RF current to flow backward into the power supply. Capacitor C2 is a DC blocking capacitor. Capacitor C3 is also a DC blocking capacitor, and capacitor C3 also acts as a feedback circuit. Capacitor C3 provides a feedback signal to the gate of transistor M0 based on output the signal at Tap2, but prevents full power from going to the gate of transistor M0.

Laser tube 110 has a capacitance present between node N1 and the housing of the laser tube 110. This capacitance may be, at the very least, parasitic due to insulating structural supports for the electrodes and the free space between the electrodes and the housing. In some embodiments, this capacitance may be deliberately increased to increase the Q-factor of the laser tube. The parallel combination of this capacitance and L1 determines the resonant frequency of laser tube 110.

Although transistor M0 is used as the active device in one embodiment, in other embodiments, a different type of active device may be employed, as shown in FIG. 1B in one embodiment.

FIG. 1B shows a block diagram of an embodiment of oscillator 100B, which may be employed as an embodiment of oscillator 100 of FIG. 1A. Oscillator 100B is similar to oscillator 100A, except that a tube (e.g. triode V1) is used as the active device in oscillator 100B rather than a transistor. In other embodiments, the active device may be a tetrode, a pentode, or the like.

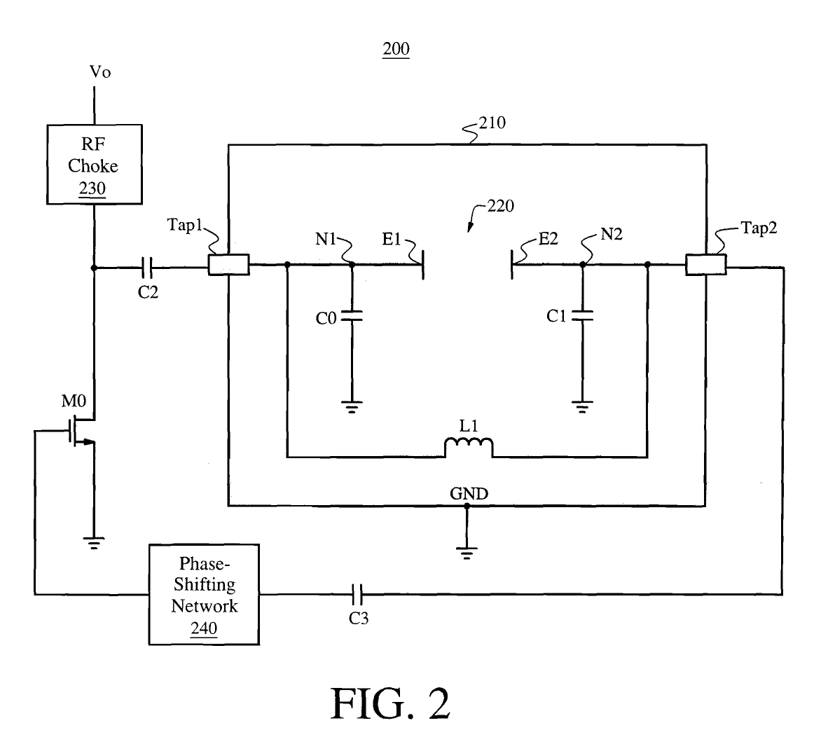

FIG. 2 illustrates a block diagram of an embodiment of oscillator 200, which may be employed as an embodiment of oscillator 100 of FIG. 1A. In oscillator 200, transistor M0 operates class E.

A simple Colpitts oscillator has a phase shift of 180 degrees. To achieve class E operation, a phase of 196 degrees is employed. Accordingly, to achieve class E operation, an embodiment of Colpitts oscillator 100 in which the phase shift is 196 rather than 180 degrees may be employed. However, the designer must keep in mind the differences between a gas load and a simple load. Design of a class E oscillator with a gas load (which tends to act as a power-dependent, frequency-dependent load) is more complex than design of a class E oscillator with a simple resistive load.

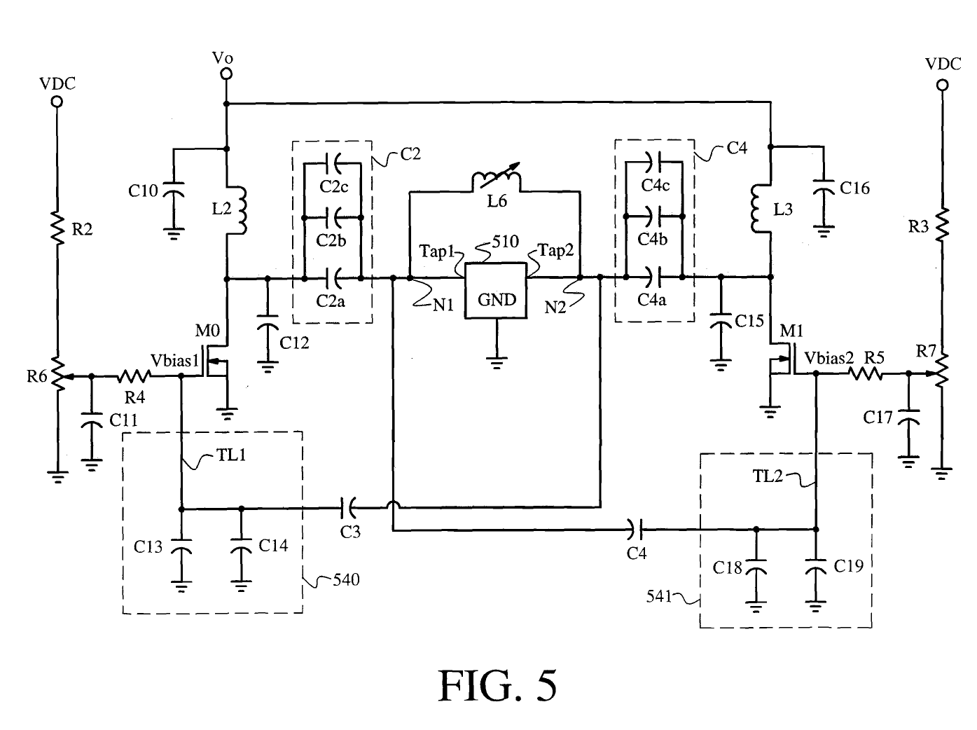

One embodiment of oscillator 200 is illustrated in FIG. 2, which may be employed as an embodiment of oscillator 100 of FIG. 1A. Oscillator 200 further includes phase-shifting network 240, which includes reactive components for creating an overall phase shift of approximately 196 degrees as measured between the drain and gate of the active device (e.g. transistor M0) of oscillator 200. One embodiment of a phase-shifting network is illustrated in FIG. 5 below. Although FIG. 2 illustrated phase-shifting network in series with capacitor C3, in another embodiment, the phase-shifting network is in series with capacitor C2 rather than capacitor C3.

Although FIG. 2 illustrates a particular configuration for achieving class E operation for the power transistor (e.g. transistor M0), the invention is not so limited, and other configurations that achieve class E operation for the power transistor are within the scope and spirit of the invention. Further, not all embodiments of the invention operate class E, such as the circuit illustrated in FIG. 1A.

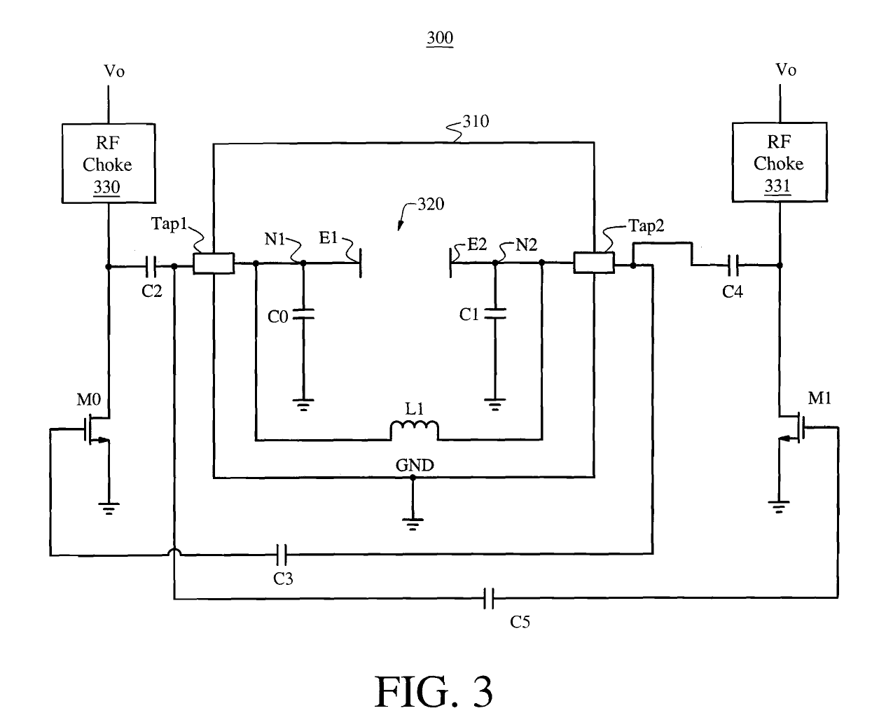

FIG. 3 illustrates a block diagram of an embodiment of oscillator 300, which may be employed as an embodiment of oscillator 100 of FIG. 1A. Oscillator 300 further includes transistor M1, RF choke 234, capacitor C4, and capacitor C5.

Oscillator 300 is arranged as a dual Colpitts oscillator with laser tube 310 as the feedback pi-network of the dual Colpitts oscillator. The dual transistor version provides roughly double the power to the laser tube as the single transistor version. Further, the embodiment of oscillator 300 illustrated in FIG. 3 is highly symmetrical, with the circuit topology for power transistor M1 being essentially a mirror image of the circuit topology for power transistor M0, and has a balanced RF load. This helps to reduce ancillary discharges to ensure proper operation of the laser.

As previously discussed, the active device such as power transistors M0 and M1 may be replaced with other types of active devices, power grid tubes, or the like.

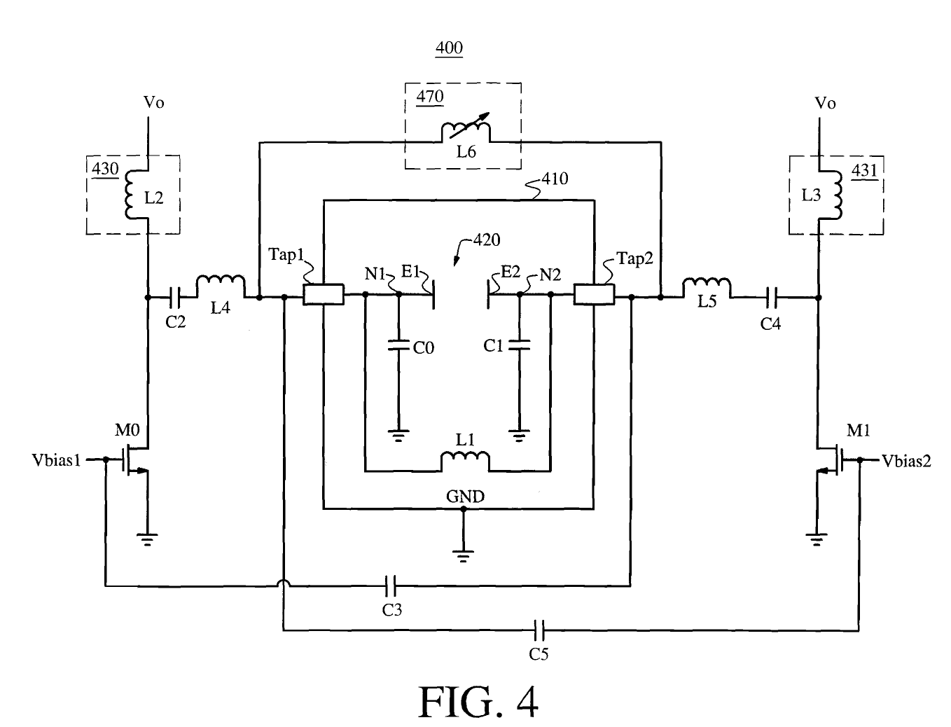

FIG. 4 shows a schematic diagram of an embodiment of oscillator 400, which may be employed as an embodiment of oscillator 300 of FIG. 3. Oscillator 400 farther includes inductor L4, inductor L5, and reactive component 470. In one embodiment, reactive component 470 includes inductor L6. RF choke 430 includes inductor L2. RF choke 431 includes inductor L3.

Bias voltages Vbias1 and Vbias2 are applied to the gate of transistors M0 and M1 respectively at a voltage close to the threshold voltage of the transistor to ensure that oscillation begins.

Reactive component 470 is mounted external to laser tube 410. In some embodiments, the reactance of reactive component 470 may be pre-selected so as to compensate for the net reactance of the oscillator circuitry outside of laser tube 410, at the frequency of oscillation of laser tube 410. In some embodiments, the frequency of operation of laser tube 410 is equal to the resonant frequency of laser tube 410. In other embodiments, the frequency of operation of laser tube 410 is relatively close to but slightly different than the frequency of oscillation of laser tube 410.

In some embodiments, the oscillation circuitry outside of laser tube 410 is net inductive. In these embodiments, reactive component 470 may be an adjustable capacitor. In other embodiments, the oscillation-circuitry outside of laser tube 410 is net capacative. In these embodiments, reactive component 470 may be an inductor.

In one embodiment, reactive component 470 is inductor L6. Inductor L6 is mounted external to laser tube 410. Inductor L6 is adjustable while the laser is operating. In one embodiment, L6 is an air-coiled inductor with an inductance that may be adjusted by physically compressing or stretching the coil, thus allowing the inductance to be adjusted by about 5% to 10% from the nominal inductance of the coil. In other embodiments, the inductance is adjustable in other ways.

The inductance value of inductor circuit L1 may vary from part-to-part. However, inductor L1 is inside the laser tube box 410 and is therefore inaccessible after laser tube 410 has been assembled. However, external inductor L6 is accessible outside of the laser tube, and therefore may be used to fine tune the total equivalent inductance between nodes N1 and N2, in order to fine-tune the frequency and the longitudinal RF voltage distribution along the gas discharge length of the laser for optimal laser performance. Taps Tap1 and tap2 may be placed on the laser tube 410 in such a way that, when the inductance between nodes N1 and N2 is properly fine-tuned by adjusting inductor L6, a uniform voltage standing wave occurs in laser tube 410. This results in improved laser performance since the electric field is therefore substantially the same everywhere in laser tube 410.

FIG. 5 schematically illustrates of an embodiment of oscillator 500, which may be employed as an embodiment of oscillator 400 of FIG. 4. Oscillator 500 further includes resistors R2-R5, adjustable resistors R6 and R7, capacitors C10-C12 and C15-C17. Phase-shifting network 540 includes capacitor C13, capacitor C14, and transmission line TL1. Phase-shifting network 541 includes capacitor C18, capacitor C19, and transmission line TL2. Capacitor C2 includes capacitors C2a-C2c. Resistors R2, R4, adjustable resistor R6, and capacitor C11 operate to provide bias voltage Vbias1 from voltage VDC to bias the gate of transistor M0. Similarly, Resistors R3, R5, adjustable resistor R7, and capacitor C17 operate to provide bias voltage Vbias2 from voltage VDC to bias the gate of transistor M1.

As previously discussed, a simple Colpitts oscillator has a phase shift of 180 degrees. To achieve class E operation, a phase of 196 degrees is employed. In oscillator 500, phase-shifting network 540 includes reactive components for creating an overall phase shift of approximately 196 degrees as measured between the drain and gate of one of the active devices the active device (e.g. transistor M0) of oscillator 500. Phase-shifting network 541 includes reactive components for creating an overall phase shift of approximately 196 degrees as measured between the drain and gate of the other active device (e.g. transistor M1) of oscillator 500.

Although FIG. 5 illustrates one embodiment of phase shifting network 540 for achieving class E operation, other embodiments of a phase-shifting network for achieving class E operation are within the scope and spirit of the invention. Further, some embodiments of the invention are not class E.

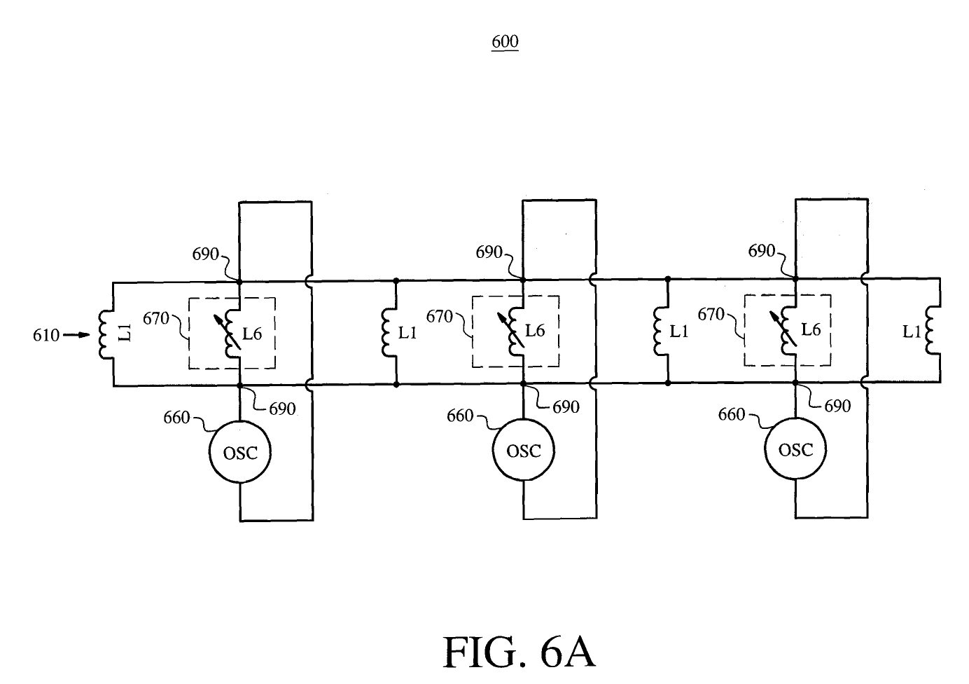

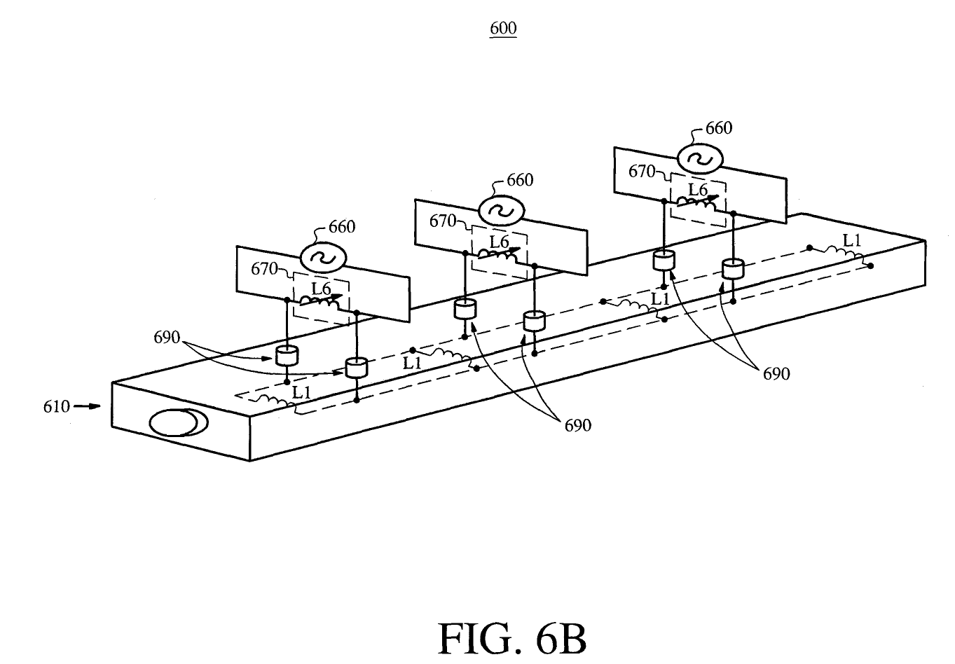

FIG. 6A shows a block diagram of an embodiment of laser device 600, which may be employed as an embodiment of oscillator 100 of FIG. 1. The laser tube includes additional RF connections (i.e. taps) 690 along the length of the laser tube at positions that correspond to the location of internal inductors. In this embodiment, the oscillators lock together at the one frequency although not necessarily at the same phase. FIG. 6A illustrates an embodiment with a single Colpitts oscillator at each pair of taps 690.

Internal inductive coils L1 are distributed along the length of laser tube 610. In one embodiment, internal inductive coils L1 are distributed uniformly along the length of laser tube 610. Each of the reactive components 670 is coupled between a separate corresponding pairs of taps 690. Each pair of taps 690 includes a first tap that is coupled to the first electrode E1 (not shown in FIG. 6A) and a second tap that is coupled to the first electrode E2 (not shown in FIG. 6A). In the embodiment illustrated in FIG. 6, each of the oscillator circuits 660 is coupled to a separate corresponding pairs of taps. Also, in this embodiment, each of the oscillator circuits 660 provides RF power to at least one of the taps that it is coupled to. RF power to the laser tube is substantially increased by have multiple oscillators circuits 660 distributed along the length of laser tube 610, rather than just one. The laser structure is resonant to the operating frequency fₒ of inductive coils L1.

In some embodiments, some of the oscillator circuits 660 may be replaced with RF power amplifiers.

FIG. 6B shows a three-dimensional perspective of an embodiment of laser device 600.

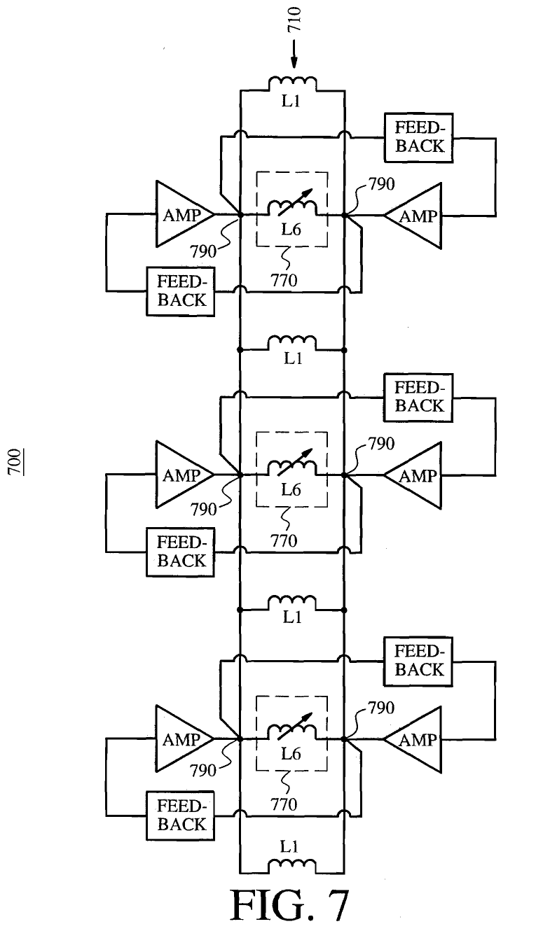

FIG. 7 illustrates an embodiment of laser device 700, which may be employed as an embodiment of laser device 600 of FIG. 6A. FIG. 7 illustrates an embodiment with a dual Colpitts oscillator at each pair of taps 790.

In one embodiment, the reactance of each of the adjustable reactive devices 770 may be pre-determined according to the following calculations.

In this example, Lₜₐₚ, is the inductance of each of coil L1 that is placed between the taps of a dual power oscillator on a laser tube to produce a uniform voltage distribution along the length of the tube for RF operating frequency, fₒ, while compensating for the dual power oscillator circuit capacitances C_{osc} that are in shunt with each tap. The total capacitance measured at either tap of the laser tube is Cₜₐₚ. (Each of the lumped capacitances C0 and C1 is Cₜₐₚ/2; the parallel capacitance of C0 and C1 is measured as Cₜₐₚ). The resonant frequency of the tube with only the N internal coils and none of the M dual power oscillators installed is fₜₐₚ. The inductance value of each of the N internal coils is L_{coil}. Adding M coils of inductance value, L_{coil}, across the taps would raise the resonant frequency to fₒ if the capacitances, C_{osc}, were not present. Therefore an additional inductance, L_{osc}, must be added across each of the taps as well to eliminate the power oscillator circuit capacitance. Capacitances Cₒₛₛ and Cᵢₛₛ represent the output and input capacitance, respectively, of each of the power devices. In one embodiment of laser device 700, an oscillator as shown in FIG. 6A is at each of the taps. For example, in FIG. 5, Cₒₛₛ is the capacitance at the drain of transistor M0, Cₒₛₛ is also the capacitance at the drain of transistor M1, Cᵢₛₛ is the capacitance at the gate of transistor M0, and Cᵢₛₛ is also the capacitance at the gate of transistor M1. In one example embodiment, N=4 and M=3.

$${f}_{tap} \text{:} = {f}_{o} \cdot \sqrt{\frac{N}{N + M}}$$

$${L}_{coil} : = N \cdot {[ {( 2 \cdot π \cdot {f}_{tap} )}^{2} \cdot \frac{{C}_{tap}}{4} ]}^{- 1}$$

As previously discussed, L_{coil} is the inductance value of each of the N individual coils. L_{coil} is pre-determined by the designer as the having an inductance corresponding to the reactance (at frequency fₜₐₚ) conjugate to the total equivalent capacitance inside the tube at frequency fₜₐₚ. The parallel combination of the N coils is resonant with the series combination of C0 and C1 at frequency fₜₐₚ. The capacitance at C0 and C1 is Cₜₐₚ/2 each, and the series combination of C0 and C1 is Cₜₐₚ/4.

$${C}_{osc} \text{:} = \frac{{C}_{2} \cdot ( {C}_{12} + {C}_{oss} )}{{C}_{2} + ( {C}_{12} + {C}_{oss} )} + \frac{{C}_{29} \cdot ( {C}_{17} + C 8 + {C}_{iss} )}{{C}_{29} + ( C 17 + C 18 + {C}_{iss} )}$$

$${L}_{osc} \text{:} = {[ {( 2 \cdot π \cdot {f}_{o} )}^{2} \cdot \frac{{C}_{osc}}{2} ]}^{- 1}$$

C_{osc} is the total equivalent capacitance of each single oscillator. The total equivalent capacitance of the dual oscillator is C_{osc}/2. If only a single Colpitts oscillator were used, the total equivalent capacitance of the oscillator would be simply C_{osc}. The inductance L_{osc} is pre-determined as the inductance corresponding to the reactance conjugate of total equivalent capacitance of the dual oscillator at the operation frequency fₒ.

In one embodiment of the invention, L_{osc} as given in the above equation is the inductance that is used for inductor L6.

In other embodiments, external inductors L6 may also be used as substitute positions for locations of some of the inductors L1 internal to the laser tube. For example, in the embodiment described above, there are four internal coils and three external inductors. The external inductor values may be selected in such a way that they function in a similar manner to the internal inductors, and also provide compensation for the oscillator circuit. In this way, even though there are only four internal coils, it is as if there are seven internal coils. The four internal coils are evenly spaced within the laser tube. Each pair of taps, with the corresponding external inductor L6, is placed evenly between two adjacent pairs of internal coils, which amounts to seven uniformly distributed coils, each having an inductance of L_{coil}.

In this embodiment, the inductance Lₜₐₚ for each inductor L6 is pre-determined as the parallel combination of L_{coil} and L_{osc}.

$${L}_{tap} \text{:} = \frac{{L}_{osc} \cdot {L}_{coil}}{{L}_{osc} + {L}_{coil}}$$

In this embodiment, the Lₜₐₚ value calculated above is used as the nominal inductance for each of the inductors L6. During operation of the laser, the inductors L6 are further adjusted to achieve maximum laser output.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A device for an RF-excited gas laser, comprising:
a Colpitts oscillator including a laser tube, wherein the Colpitts oscillator is arranged such that the laser tube is the feedback pi-network of the Colpitts oscillator.

2. The device of claim 1, wherein the laser tube includes a discharge region that is designed to include a gas load therein.

3. The device of claim 2, wherein the laser tube includes an inductor circuit in parallel with the discharge region.

4. The device of claim 1, wherein the laser tube further includes a first electrode and a second electrode, the first and second electrodes are disposed on opposite sides of the discharge region, the first electrode is coupled to a first node, the second electrode is coupled to a second node, and wherein the laser tube further includes an inductor circuit that is coupled between the first and second nodes.

5. The device of claim 4, wherein the laser tube includes a first tap that is coupled to the first electrode, and a second tap that is coupled to the second electrode.

6. The device of claim 5, wherein the Colpitts oscillator further includes:
a power transistor having at least a gate that is coupled to a third node, a drain that is coupled to a fourth node, and a source;
at least one reactive component that is coupled between the fourth node and the first node; and
a feedback circuit that is coupled between the second node and the third node.

7. The device of claim 6, further comprising an RF choke that is coupled to the fourth node.

8. The device of claim 6, wherein the feedback circuit includes a DC blocking capacitor.

9. The device of claim 6, wherein the Colpitts oscillator further includes an adjustable inductor mounted on the laser tube external to the laser tube, wherein the adjustable inductor is coupled between the first node and the second node.

10. The device of claim 6, wherein the Colpitts oscillator further includes a phase-shifting network that is configured such that the power transistor operates class E.

11. The device of claim 6, further comprising:
another Colpitts oscillator that includes the laser tube, and wherein the laser tube further includes another inductor circuit that is coupled between the first and second nodes.

12. The device of claim 6, further comprising a plurality of additional Colpitts oscillator such that each of the Colpitts oscillators is disposed uniformly along the laser tube, and wherein the laser tube include an additional pair of taps for each of the additional Colpitts oscillators.

13. The device of claim 6, wherein the Colpitts oscillator is a dual Colpitts oscillator.

14. The device of claim 13, wherein the Colpitts oscillator further includes:
another power transistor having at least a gate that is coupled to a fifth node, a drain that is coupled to a sixth node, and a source;
another reactive component that is coupled between the sixth node and the second node; and
another feedback circuit that is coupled between the first node and the fifth node.

15. The device of claim 6, wherein the at least one reactive component includes a DC blocking capacitor.

16. The device of claim 15, wherein the at least one reactive component further includes an inductor in series with the DC blocking capacitor.

17. A device for an RF-excited gas laser, comprising:
a laser tube that is arranged to receive an RF signal; and
oscillation circuitry, including: a transistor and at least one passive component, wherein the oscillation circuitry is arranged such that the transistor employs class E operation to provide the RF signal.

18. A method for an RF-excited gas laser, comprising:
employing an RF-excitable laser tube having at least first and second taps to generate a laser, wherein employing the RF-excitable laser tube includes:
providing a bias voltage to a gate of a power transistor;
providing a signal at the drain of the power transistor to the first tap of the RF-excitable laser tube; and
providing a feedback voltage to the gate of the power transistor, based in part on a signal provided at the second tap of the RF-excitable laser tube, such that the voltage at the drain of the power transistor oscillates, wherein the voltage oscillation causes plasma breakdown of a gas load in the RF-excitable laser tube to generate the laser.

19. The method of claim 18, further comprising:
further adjusting the feedback voltage such that the power transistor operates class E.

20. The method of claim 18, further comprising:
adjusting an inductance between the first tap and the second tap during operation of the laser.
